(19) United States
(12) Patent Application Publication
(10) Pub. No.: US 2023/0140135 A1
(43) Pub. Date: May 4, 2023

(54) FIRE SUPPRESSION APPARATUS

(71) Applicant: Pax Products, LLC, Coeur D'Alene, ID (US)

(72) Inventor: Jacob Clarence Schuler, Colbert, WA (US)

(73) Assignee: Pax Products, LLC, Coeur d'Alene, ID (US)

(21) Appl. No.: 17/977,713

(22) Filed: Oct. 31, 2022

Related U.S. Application Data
(60) Provisional application No. 63/274,481, filed on Nov. 1, 2021.

(51) Int. Cl. A62C 35/08

(52) U.S. Cl. CPC A62C 35/08

(57) ABSTRACT

In aspects of a fire suppression apparatus, an elongated housing contains one or more fire extinguishing agents, and an explosive charge within the elongated housing. A trigger fuse ignites reactive to flame exposure, and the trigger fuse activates the explosive charge to expel the one or more fire extinguishing agents. Multiple fire suppression apparatuses can be linked for deployment in the path of a fire.

### RELATED APPLICATION

This application claims priority to U.S. Provisional Patent Application Ser. No. 63/274,481 filed Nov. 1, 2021 entitled “Fire Suppression Apparatus and Method”, the disclosure of which is incorporated by reference herein in its entirety.

### BACKGROUND

Fire suppression systems and devices typically rely on the availability of considerable quantities of pressurized water and/or relatively expensive infrastructure, such as a building fire suppression system. Considerable user training may also be an important prerequisite to using various fire suppression systems and devices.

### BRIEF DESCRIPTION OF THE DRAWINGS

The detailed description is described with reference to the accompanying figures.

FIG. 1 illustrates an example cross-sectional schematic view of a fire suppression apparatus in accordance with one or more implementations as described herein.

FIG. 2 illustrates an example of fire suppression apparatuses in a fire suppression system in accordance with one or more implementations as described herein.

FIG. 3 illustrates another example cross-sectional schematic view of a fire suppression apparatus in accordance with one or more implementations as described herein.

FIG. 4 illustrates an example perspective view of a fire suppression apparatus in accordance with one or more implementations as described herein.

FIG. 5 illustrates an example configuration of a fire suppression system in accordance with one or more implementations of a fire suppression apparatus as described herein.

FIG. 6 illustrates a use example of a fire suppression system in accordance with one or more implementations of a fire suppression apparatus as described herein.

FIG. 7 illustrates example configurations of a fire suppression system in accordance with one or more implementations of a fire suppression apparatus as described herein.

FIG. 8 illustrates another use example of a fire suppression system in accordance with one or more implementations of a fire suppression apparatus as described herein.

FIG. 9 illustrates example method(s) for a fire suppression apparatus in accordance with one or more implementations, as described herein.

### DETAILED DESCRIPTION

Aspects of a fire suppression apparatus are described in this disclosure as a versatile blaze barrier to advancing fire, and in one or more implementations, is a grassland and/or wildfire suppression device that can be placed in the path of an advancing fire for activation to suppress the fire. In the fire-fighting industry, fire suppression systems and devices typically rely on the availability of considerable quantities of pressurized water and/or relatively expensive infrastructure, such as a building fire suppression system. Considerable user training may also be an important prerequisite to using typical fire suppression systems and devices. While suitable and effective in some application settings, such as protecting the interior of buildings in an urban setting, many fire-fighting approaches are generally unsuitable for responding to and controlling grassland and wildfires.

This disclosure describes a fire suppression apparatus, as well as a fire suppression system configured with multiple fire suppression apparatuses linked for planned or rapid deployment in the path of an approaching fire. Similarly, any number of individual (non-linked) fire suppression apparatuses can be placed to mitigate and suppress the flames of an approaching fire. Notably, a fire suppression apparatus, or a fire suppression system of multiple fire suppression apparatuses, can be placed at a safe distance from an approaching wildfire, and are then activated as the flames advance to suppress the fire. A fire suppression system of multiple fire suppression apparatuses can be quickly deployed in the face of advancing flames, such as linked fire suppression apparatuses that are rolled off or otherwise distributed from a vehicle encircling the beginnings of a grassland or wildfire. Additionally, fire suppression apparatuses can be readily carried in a backpack or in a saddle-borne dispenser on a horse or ATV to facilitate transport through rough and challenging terrain and/or in urban settings, such as to protect an escape route out of a fire.

The described techniques for rapid deployment of a fire suppression apparatus, or a fire suppression system of multiple fire suppression apparatuses, can substantially mitigate the damage otherwise caused by grassland and wildfires for considerable financial savings, as well as saving natural resources, property, homes, and lives. Alternatively, or in addition, a fire suppression system (e.g., of multiple fire suppression apparatuses) can be distributed as a barrier to potential or expected fire well in advance of a fire beginning For example, a property owner can deploy fire suppression apparatuses around property to protect land and/or buildings from potential fire damage.

In one or more implementations, a fire suppression apparatus as described herein has an elongated housing, such as in a tubular form. Unlike an approximate spherical, or generally ball-shaped device, the described elongated housing of the fire suppression apparatus distributes fire extinguishing agents in substantially two directions. For example, the fire suppression apparatus distributes the fire extinguishing agents in a first direction towards the flames to suppress the advancing fire, and distributes the fire extinguishing agents in a second direction, opposite the first direction, to protect unburned fire fuel. This front-to-back distribution of the fire extinguishing agents from the elongated housing of the fire suppression apparatus both suppresses the fire and eliminates potential fire fuel sources over a wider coverage area (e.g., front-to-back) than can be attained with a typical spherical device.

Although aspects of a fire suppression apparatus are described herein primarily for grassland and/or wildfire suppression, alternate forms of the fire suppression apparatus can be implemented to mitigate potential fire in other scenarios. For example, various form factors of the described fire suppression apparatus can be utilized for fire protection and mitigation in buildings, spaces, and for other scenarios than grassland and wildfires. In an implementation, a fire suppression apparatus may have an approximate half-circle cross-section to facilitate mounting the apparatus to a wall, or a quarter-circle cross-section to facilitate mounting the apparatus in a junction where a wall meets a ceiling in a building. In one or more implementations, a fire suppression apparatus can be integrated into construction and building materials to mitigate fire damage in buildings and other structures. Further, fire suppression apparatuses can be implemented in cargo containers on ships, in airplanes, or in places on other types of vehicles where a fire likely may occur, such as in motorhomes, travel trailers, and other recreational vehicles.

In some aspects of the techniques described herein, a fire suppression apparatus includes an elongated housing configured to contain one or more fire extinguishing agents, an explosive charge within the elongated housing, and at least one trigger fuse configured to ignite reactive to flame exposure, the at least one trigger fuse activating the explosive charge to expel the one or more fire extinguishing agents.

In some aspects of the techniques described herein for a fire suppression apparatus, at least the elongated housing and the one or more fire extinguishing agents are biodegradable.

In some aspects of the techniques described herein for a fire suppression apparatus, the elongated housing is formed from natural earthen elements.

In some aspects of the techniques described herein for a fire suppression apparatus, the one or more fire-extinguishing agents are biodegradable fertilizers.

In some aspects of the techniques described herein for a fire suppression apparatus, the elongated housing is configured to distribute the one or more fire extinguishing agents in two directions responsive to the explosive charge activating, the one or more fire extinguishing agents distributable in a first direction towards a fire and distributable in a second direction opposite the first direction.

In some aspects of the techniques described herein for a fire suppression apparatus, the one or more fire extinguishing agents distributed in the first direction are configured to suppress the fire, and the one or more fire extinguishing agents distributed in the second direction are configured to protect unburned fire fuel.

In some aspects of the techniques described herein for a fire suppression apparatus, the elongated housing is configured with a waterproof sealant, and wherein the waterproof sealant is configured to melt due to the flame exposure, exposing the at least one trigger fuse to a fire.

In other aspects of the techniques described herein, a fire suppression system includes a first fire suppression apparatus containing one or more fire extinguishing agents configured to expel from an elongated housing responsive to an explosive charge activated by a trigger fuse ignited by flame exposure, and at least a second fire suppression apparatus linked for deployment with the first fire suppression apparatus.

In some aspects of the techniques described herein for a fire suppression system, at least the elongated housing and the one or more fire extinguishing agents are biodegradable.

In some aspects of the techniques described herein for a fire suppression system, the elongated housing is formed from natural earthen elements.

In some aspects of the techniques described herein for a fire suppression system, the one or more fire-extinguishing agents are biodegradable fertilizers.

In some aspects of the techniques described herein for a fire suppression system, the elongated housing is configured to distribute the one or more fire extinguishing agents in a first direction to suppress a fire responsive to the explosive charge activated by the trigger fuse.

In some aspects of the techniques described herein for a fire suppression system, the elongated housing is configured to distribute the one or more fire extinguishing agents in a second direction, opposite the first direction, to protect unburned fire fuel responsive to the explosive charge activated by the trigger fuse.

In some aspects of the techniques described herein for a fire suppression system, multiple fire suppression apparatuses, including the first fire suppression apparatus and at least the second fire suppression apparatus, are linked for deployment in a path of a fire.

In other aspects of the techniques described herein, a method includes containing one or more fire extinguishing agents, igniting, by an approaching flame, a trigger fuse, activating an explosive charge by the trigger fuse, and expelling the one or more fire extinguishing agents by the explosive charge.

In some aspects of the techniques described herein, distributing the one or more fire extinguishing agents in a first direction to suppress a fire responsive to activating the explosive charge.

In some aspects of the techniques described herein, distributing the one or more fire extinguishing agents in a second direction to protect unburned fire fuel responsive to activating the explosive charge.

In some aspects of the techniques described herein, igniting the trigger fuse is based on a waterproof element that melts to expose the trigger fuse to fire.

In some aspects of the techniques described herein, a fire suppression apparatus contains the one or more fire extinguishing agents configured for expelling from an elongated housing responsive to activating the explosive charge by the trigger fuse.

In some aspects of the techniques described herein, multiple of the fire suppression apparatus are linked for deployment as a barrier in a path of an advancing fire, and the multiple fire suppression apparatuses are deployable from a vehicle in the path of the advancing fire.

In other aspects of the techniques described herein, a deployment technique includes a fire suppression system deploying rope-like from a transport, the fire suppression system including multiple, linked fire suppression apparatuses.

In some aspects of the deployment technique described herein, the transport is one of a container of the multiple, linked fire suppression apparatuses or a reel on which the multiple, linked fire suppression apparatuses are spooled.

While features and concepts of the described techniques for a fire suppression apparatus can be implemented in any number of different devices, systems, environments, and/or configurations, implementations of the techniques for a fire suppression apparatus are described in the context of the following example devices, systems, and methods.

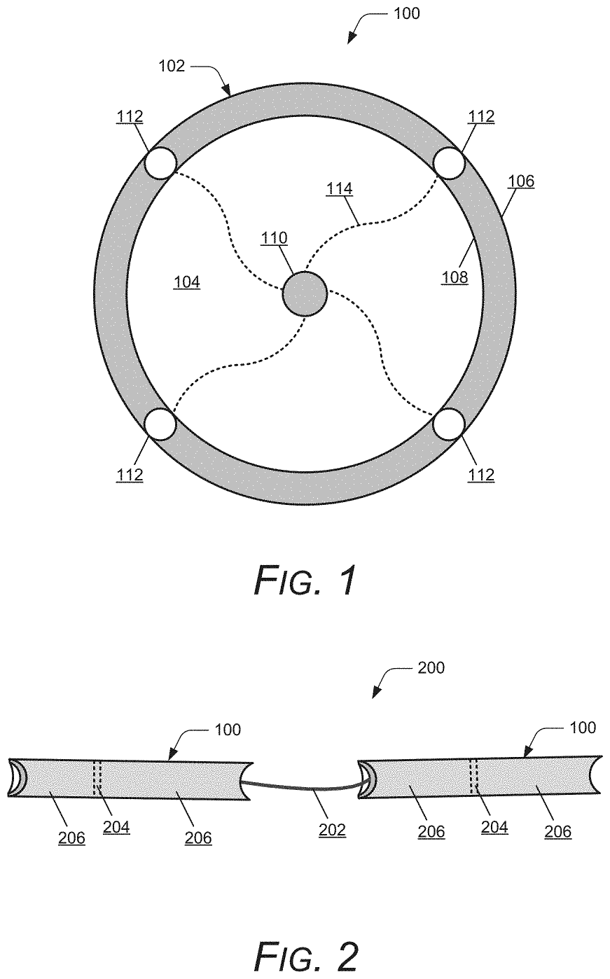

FIG. 1 illustrates an example cross-sectional schematic view of a fire suppression apparatus 100 in accordance with one or more implementations as described herein. In this example, the fire suppression apparatus 100 has an elongated housing 102 that contains one or more fire extinguishing agents 104. The elongated housing 102 includes an outer sheath 106 and an interior container 108. The fire suppression apparatus 100 also has an explosive charge 110 located within the elongated housing 102. In this example, the fire suppression apparatus 100 has trigger fuses 112 integrated in the elongated housing. A trigger fuse 112 ignites reactive to flame exposure (e.g., by advancing wildfire flames), and the trigger fuse 112 activates the explosive charge 110 to expel the one or more fire extinguishing agents 104. When a trigger fuse 112 is ignited reactive to flame exposure, an internal portion 114 (e.g., a trigger-to-charge) of the fuse burns down to activate the explosive charge 110.

Although the fire suppression apparatus 100 is illustrated as having four trigger fuses 112 in this example, a fire suppression apparatus can include any number and configuration of one or more trigger fuses, such as further described and shown with reference to FIG. 3. In this example fire suppression apparatus 100, the four trigger fuses 112 are each disposed at ninety-degrees (90°) relative to a next adjacent trigger fuse. This configuration provides that at least one trigger fuse 112 will be exposed to proximal flames regardless of how the device is deployed, which avoids the necessity for careful deployment and permits rapid deployment by persons having very little training. In implementations, the trigger fuses 112 are each a cotton string soaked in a gunpowder mixture. The trigger fuses 112 can be implemented as any type of combustible fuse, such as may be found in fireworks. In aspects of the fire suppression apparatus 100, the trigger fuses 112 are not limited to the described implementation, but rather can accommodate other approaches of detecting and responding to the proximity of a flame, such as by use of chemically-based sensors, optical sensors, electro-mechanical sensors, remote sensing, and/or manually initiated triggers.

Additionally, the explosive charge 110 housed in the fire suppression apparatus 100 is black powder or a similar equivalent, which can be made of natural nitrates, sulfur, and cellulose charcoal, all of which are natural materials. Generally, black powder is classified as a low explosive because of its relatively slow decomposition rate and consequently low brisance. Low explosives burn at subsonic speeds and produce propulsive forces that serve well for the implementation in the fire suppression apparatus 100, as described herein. Alternatively, or in addition, other mechanisms, such as other chemical reactions, pyrotechnic charges, compressed gas, or the like may be used.

The elongated housing 102 includes the outer sheath 106 and the interior container 108. In implementations, the components of the elongated housing 102 are formed from natural earthen elements and are biodegradable. Additionally, the elongated housing 102 can include capsule walls and interior dividers that are made of cellulose-based cardboard. The containment barriers inside the housing shell can be formed with unprocessed bentonite clay for directional control, a natural earthen element. To prevent incineration of the fire suppression apparatus 100 in the heat front of a wildfire prior to direct contact with the flames, the entire apparatus excluding the trigger fuse (or trigger fuses) is sealed with a sodium silicate mixture that decomposes into silicate sand over time. Further, the elongated housing 102 is ultra-violet (UV) light resistant to avoid material degradation during lengthy periods while exposed to sunlight, and is configured with a waterproof sealant, such as a printed poly-lactic acid-based (PLA) wrap, which is derived from corn. In implementations, the waterproof sealant melts due to the flame exposure, which exposes one or more of the trigger fuses to the flames of a fire.

In alternative implementations, the outer sheath 106 can be formed from any suitable material, is waterproof and, at least to some extent, is resistant to puncturing, tearing, or other similar damage, such as when stored and during deployment for fire suppression. As shown in this example, the elongated housing 102 of the fire suppression apparatus 100 has a substantially circular cross-section, and can be implemented of any size diameter (e.g., ¾″, 2″, 4″, and so forth), depending on application and deployment factors. Similarly, the length of the elongated housing 102 can vary depending on storage, transport, and deployment factors (e.g., any lengths, such as 6″, 8″, 12″, 24″, and so forth). A wide variety of alternative material implementations are possible, including the use of other suitable materials for the components of the elongated housing (e.g., tubing), such as fabrics, woven or spun tubing, other biodegradable materials, closed cell foams, and/or applied coatings or chemicals. Further, a fire suppression apparatus 100 may be implemented in other form factors, yet can still be linearly linked or strung together to form a fire suppression system. For implementations that include foam or liquid fire extinguishing agents, the fire suppression apparatus 100 can be implemented to maintain its integrity and contain the fire extinguishing agents with a canister or any other type of liquid container.

In this example fire suppression apparatus 100, the fire extinguishing agents 104 are also biodegradable and/or are biodegradable fertilizers. The fire extinguishing chemical mono ammonium phosphate (MAP) can be used as an agricultural fertilizer, is water soluble, and easily absorbs into the soil. When exposed to flames, the MAP starts to decompose, commonly into polymeric phosphoric acid and ammonia. A carbon foam is built up on vegetation surfaces against the heat source to prevent charring. The carbon barrier acts as an insulation layer, preventing the ignition of vegetation, which effectively removes the fuel requirement of fire (e.g., a fire needs heat, oxygen, and fuel to burn). In an implementation, basic MAP can be modified with additional chemical components to increase its efficacy, such as to facilitate adherence to vegetation, or for other improvements. The chemical decomposition of MAP also uses some heat energy, slightly reducing the heat of the flames, albeit by a negligible amount.

An additional fire extinguishing chemical, sodium bicarbonate (SB), is a fire suppressant, and is also water-soluble and easily absorbs into the soil. At approximately one-hundred, eighty degrees (180°) Fahrenheit, it decomposes into carbon dioxide, sodium carbonate, and water. The expansion of carbon dioxide effectively reduces the oxygen concentration to unsuitable levels, removing the oxygen requirement of fire. The decomposition process also removes heat and captures free radicals of chain reactions. As with the MAP, the sodium bicarbonate can be mixed with other components, materials, and/or chemicals that increase its efficacy.

In one or more implementations, the fire suppression apparatus 100 contains the MAP plus SB dry powder inside of a cardboard tube (e.g., the elongated housing 102). In implementations, the length of the elongated housing 102 of the fire suppression apparatus 100 is at least or approximately a 3:1 ratio relative to its cross-section. This enables a core functionality of the device, namely dispersement of the fire extinguishing agents 104 in the two primary directions (e.g., into the flames and covering unburned fire fuels). This elongated form factor also makes the entire system (e.g., a fire suppression system) easier to deploy, takes up less space on vehicles, and increases the utility of the fire suppression apparatus for placement in long and relatively narrower areas with potential fire hazards, such as electrical conduits, engine bays, and inside building walls, to name a few examples.

Centered in the middle of the tube of the elongated housing 102 is a paper pouch of black powder. Each end of the outer elongated housing 102 has a barrier of pressed clay to direct the suppressant perpendicularly relative to the tube and not out of the ends of the housing. The ends of the cardboard tube are folded over the clay for additional strength. As further shown and described with reference to FIG. 3, a length of fast-burning fireworks fuse wraps around the tube of the elongated housing, penetrating the side and joining the black powder charge inside. Except for the fuse, the entire tube of the fire suppression apparatus 100 is submerged or sprayed with a flame retardant. Once dry, the fuse is wrapped around the tube of the elongated housing and the entire device is sealed within a biodegradable shrink tube. These individual fire suppression apparatus devices are then connected together with a natural fiber rope and placed in a cardboard box, which remains sealed until the fire suppression apparatuses are needed.

In addition to grassland and wildfire suppression use cases, there are many other opportunities to utilize this style of fire suppression apparatus or device in other settings and situations. In alternate implementations, nearly any component of the device could be changed or adapted. A trigger fuse 112 (or 308 in FIG. 3) can be implemented as a temperature, light, or visual sensor. A trigger fuse may also be implemented as a remote trigger based on some other input, or a manual trigger operated on a radio, wireless, or wired network. Other types of triggers could also send signals in other directions, such as to set off an alarm or notify a central computer system, in addition to setting off the inner charge. In alternate implementations, the explosive charge 110 may not be black powder, but rather another type of explosive or propellant, gaseous charge, interacting chemical reaction, and/or an electronic device of some kind.

Additionally, while the fire extinguishing agents (104, 304) are described as suppressant powder optimal for grassland and wildland class A fires, other powders, fluids, gasses, particles, foams, and the like may be better utilized for kitchen grease, electrical, chemical, or metallic fires (e.g., American fire classes B, C, D, and K). Further, chemicals may be added or removed to accommodate implementations, such as including flow or stickiness enhancers, florescent dyes for identification, seeds for replanting, floating oil absorbents, shelf-life enhancers, or visual/auditory effects for notification, to name a few non-limiting examples. Further, inner payloads of the fire extinguishing agents could be separated to then react when mixed. The material used to form the elongated housing (102, 302) of the fire suppression apparatus (100, 300) can be a cardboard casing of the device, or instead, may be nearly any rigid material, including plastic, silicone, metal, and wood. In the same regard, the tubular shape of the device may not be a perfect circle, but rather, can be implemented as a half or quarter-circle of the tubular shape to conform to walls or corners in buildings and other structures. As a safety implementation, a kill switch can be interposed between the trigger fuse and the explosive charge, such as to accommodate transport or maintenance of the fire suppression apparatus.

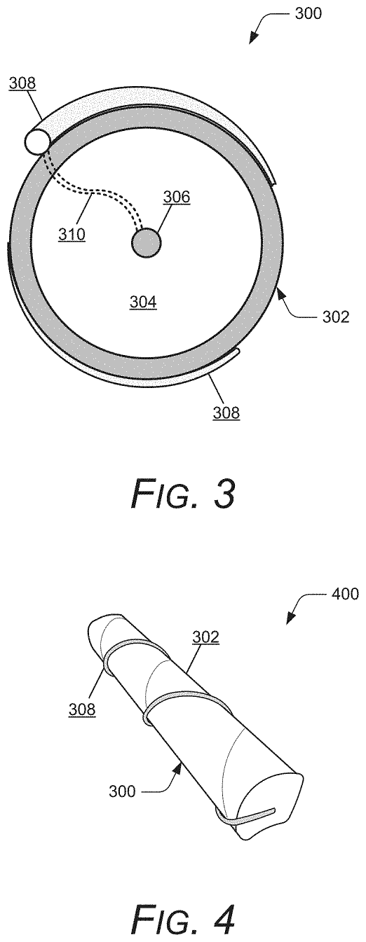

FIG. 2 illustrates an example of fire suppression apparatuses in a fire suppression system 200 in accordance with one or more implementations as described herein. In this example, the fire suppression system 200 includes a first fire suppression apparatus 100, such as shown and described with reference to FIG. 1, and includes at least a second fire suppression apparatus linked for deployment with the first fire suppression apparatus. In implementations, multiple fire suppression apparatuses are linked together, such as in a rope format or configuration, for deployment in the path of a fire. For example, the fire suppression apparatuses can be linearly-linked or strung together with natural cellulose string 202 braided or wound into ropes. The strung-together fire suppression apparatuses form the fire barrier system that can be packed and shipped in containers, ready for deployment, much like laying a rope on the ground and/or over objects.

In one or more implementations, a fire suppression apparatus 100 can be physically segmented by interior spacers 204, which segment the fire suppression apparatus to create physically and functionally discrete fire suppression modules 206 of the fire suppression apparatus. Accordingly, the flames from a fire adjacent one of these discrete fire suppression modules 206 will cause that particular module to distribute its fire extinguishing agents 104, without necessarily causing the deployment of adjacent modules. Notably, each fire suppression module 206 of a fire suppression apparatus 100 only deploys its fire extinguishing agents 104 at essentially the peak opportunity to effectively suppress an adjacent fire.

FIG. 3 illustrates another example cross-sectional schematic view of a fire suppression apparatus 300 in accordance with one or more implementations as described herein. In this example, the fire suppression apparatus 300 has an elongated housing 302 that contains one or more fire extinguishing agents 304 (such as described with reference to the fire extinguishing agents 104 of the fire suppression apparatus 100). Similar to the fire suppression apparatus 100, the elongated housing 302 includes an outer sheath and an interior container. The fire suppression apparatus 300 also has an explosive charge 306 located within the elongated housing 302 (such as described with reference to the explosive charge 110 of the fire suppression apparatus 100). In this example, the fire suppression apparatus 300 has a single trigger fuse 308 that is wound lengthwise around the elongated housing 302 of the device for three-hundred sixty degrees (360°) coverage. The trigger fuse 308 ignites reactive to flame exposure (e.g., by advancing wildfire flames), and the trigger fuse activates the explosive charge 306 to expel the one or more fire extinguishing agents 304. When the trigger fuse 308 is ignited reactive to flame exposure, an internal portion 310 (e.g., a trigger-to-charge) of the fuse burns down to activate the explosive charge 306.

FIG. 4 further illustrates an example perspective view 400 of the fire suppression apparatus 300, as shown and described with reference to FIG. 3. As shown in this example view, the trigger fuse 308 is wound lengthwise around the elongated housing 302 of the device for three-hundred sixty degrees (360°) coverage. Similar to the fire suppression system 200 as shown and described with reference to FIG. 2, multiple of the fire suppression apparatus 300 can be linked for deployment in the path of a fire. For example, the fire suppression apparatuses can be linearly linked or strung together to form a fire barrier system that can be packed and shipped in containers, ready for deployment.

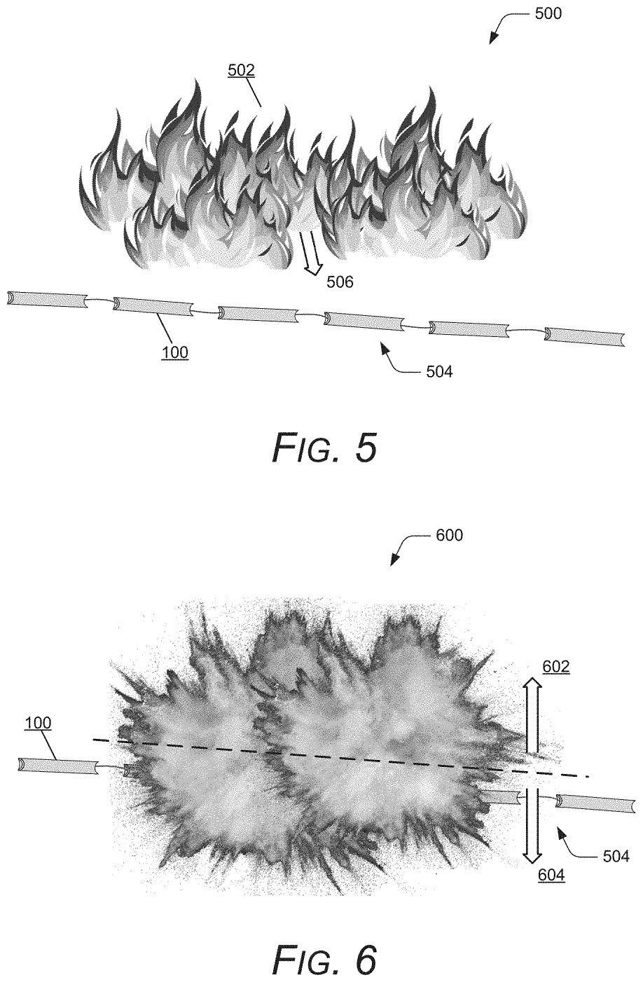

FIG. 5 illustrates an example configuration 500 of a fire suppression system in accordance with one or more implementations of a fire suppression apparatus as described herein. In this example, a ground fire 502 (e.g., a grassland fire) advances towards a deployed fire suppression system 504, as indicated by the arrow 506. The fire suppression system 504 can be implemented with linearly linked or strung-together fire suppression apparatuses (100, 300) to form the fire barrier system. In aspects of the described techniques, the fire suppression system 504 is formed with multiple of the fire suppression apparatus 100 and/or multiple of the fire suppression apparatus 300. The fire suppression apparatus barriers can be deployed any distance apart (e.g., three feet apart for a grass fire, or closer or farther apart for alternate types of fire suppression barriers).

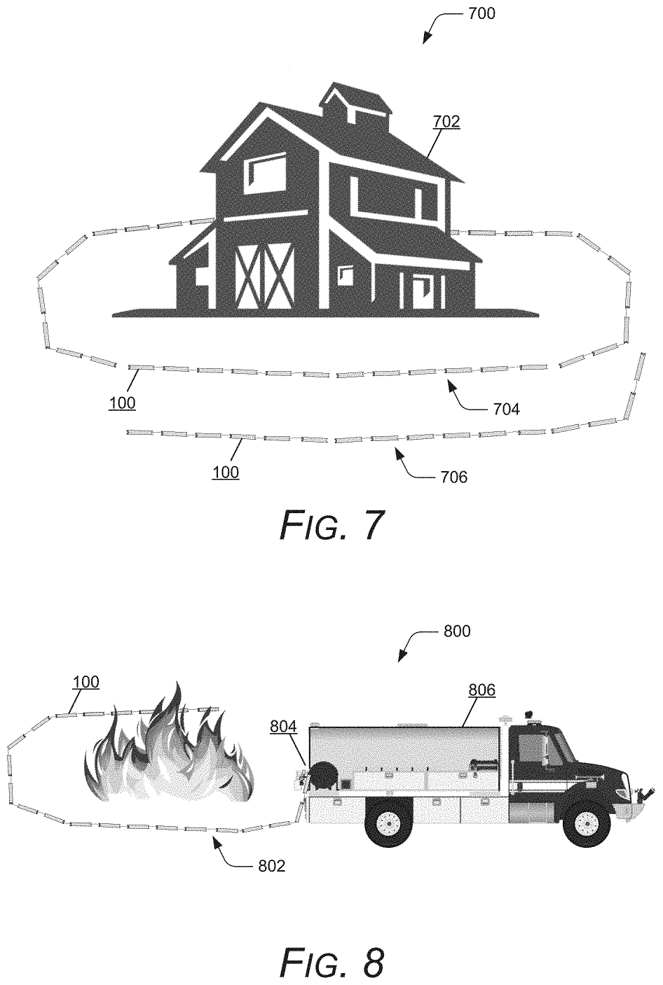

FIG. 6 illustrates a use example 600 of a fire suppression system in accordance with one or more implementations of a fire suppression apparatus as described herein. In this example 600, the advancing fire 502 (shown in FIG. 5) has reached the fire suppression system 504 and one or more of the fire suppression apparatuses are detonated, distributing the fire extinguishing agents (104, 304) to not only suppress the fire, but also protect the unburned fire fuel ahead of the advancing fire. As similarly described above, the flames from the fire 502 adjacent to one of the fire suppression apparatus (100, 300) will cause that particular device to distribute its fire extinguishing agents (104, 304). However, each of the fire suppression apparatuses of the fire suppression system 504 independently deploys its fire extinguishing agents at essentially the peak opportunity to effectively suppress a portion of the adjacent fire.

As described above with reference to FIG. 1, the fire suppression apparatus 100 has the elongated housing 102, such as in a tubular form. In one or more implementations, the elongated housing is a tube configured to distribute the one or more fire extinguishing agents 104 in two directions responsive to activation of the explosive charge 110. The fire extinguishing agents are distributed in a first direction 602 towards the fire 502 to suppress the fire, and are distributed in a second direction 604 (opposite the first direction) to protect unburned fire fuel in front of the advancing fire. This front-to-back distribution of the fire extinguishing agents 104 from the elongated housing of the fire suppression apparatus 100 both suppresses the fire and eliminates potential fire fuel sources over a wide coverage area (e.g., front-to-back).

Further to the process of fire suppression, as the fire 502 approaches the fire suppression system 504, the convective heat of the approaching flames melts the PLA waterproof sleeve, exposing the trigger fuse of the fire suppression apparatus (100, 300). The fuse and device will not melt or burn at temperatures below approximately one-thousand, eight-hundred degrees (1800°) Fahrenheit. The fuse will only ignite in direct flame and activate the explosive charge 110 inside of the fire suppression apparatus. The resulting cloud of fire suppressant and retardant (e.g., the one or more fire extinguishing agents 104) smothers the closest flames and covers the surrounding vegetation, preventing further burning. Due to the directional blast perpendicular to the barrier line, the adjoining devices remain active and ready to blow as the fire continues. This approach is particularly effective due to the air movement properties of a wildfire front, where cool air is drawn into the fire at its base (where the cloud of suppressant will be) and hot air is expelled higher up in the body and tips of the flames.

Unlike an approximate spherical, or generally ball-shaped device that delivers a synthetic, toxic, and non-biodegradable fire suppressant in a circular pattern with a higher concentration at the center, the fire suppression apparatus (100, 300) described in this disclosure distributes the same quantity of a biodegradable fire suppressant with a higher concentration along a center-line of the elongated housing (e.g., in a tube form) of the fire suppression apparatus. The fire suppression apparatus distributes the fire extinguishing agents in substantially the two directions 602, 604.

FIG. 7 illustrates example configurations 700 of a fire suppression system in accordance with one or more implementations of a fire suppression apparatus as described herein. In this example, one or more fire suppression systems are deployed to encircle property to protect an area, land, and/or building 702 from potential fire damage. A fire suppression system 704 is implemented with linked suppression apparatuses (100, 300) to form the fire barrier system, and optionally, any number of additional fire suppression systems can be deployed for redundant property protection, such as with the fire suppression system 706 shown in this example as a sequential line of fire defense.

In aspects of the described techniques, the fire suppression systems 704, 706 are formed with multiple of the fire suppression apparatus 100 and/or multiple of the fire suppression apparatus 300, as described herein. By approximately encircling the surrounding terrain of a property (e.g., an area, land, building, etc.), the property is protected from an advancing fire that approaches from generally any direction. Notably, the fire suppression apparatuses of a fire suppression system readily accommodate other deployment scenarios, such as may be secured to a fence, building, or other structure, as well as laid upon the ground or surrounding terrain. A fire suppression system can be placed or mounted around buildings or areas with a higher risk of fire, such as in an area of electrical poles, electrical substations, campgrounds, barns, or other buildings (e.g., inside and/or outside of a building).

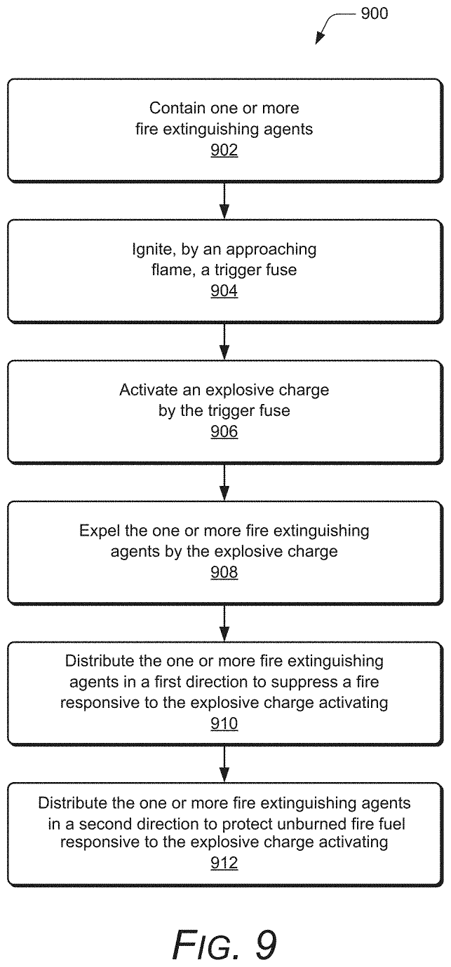

FIG. 8 illustrates another use example 800 of a fire suppression system in accordance with one or more implementations of a fire suppression apparatus as described herein. In this example, a fire suppression system 802 of linked fire suppression apparatuses (100, 300) is quickly deployed (at 804) from a first responder vehicle 806 to encircle the beginnings of a grassland or wildfire. The fire suppression system 802 is rolled off or otherwise distributed from the vehicle. In aspects of the described techniques, the fire suppression system 802 that includes multiple fire suppression apparatuses linked together can be deployed from a storage container (e.g., a box), or as in this example, unwound from a hose reel, which is attached to the first-responder fire response vehicle or to an electrical company truck for emergency response. A fire suppression system of multiple fire suppression apparatuses linked together and/or individual fire suppression apparatuses can also be transported and deployed by larger or smaller wildfire response vehicles, such as ATVs, fire trucks, bulldozers, and earthmovers having the fire suppression system and/or fire suppression apparatuses readily available for rapid deployment.

Aside from the charged devices themselves, multiple and various deployment options for the fire suppression apparatuses are contemplated. Although generally described as being linked together in a rope format, they could be used individually or in less-than-a-full-box quantities. They can be hung from trees or wrapped around them just a few at a time, such as for campsites, along electrical or gas lines, and in other high-risk areas as a preventative measure. They can be dropped from helicopters or drones, deployed off a truck or bulldozer, rolled off a reel, or pulled out of a box. They can be mounted along fences, on power poles, and under the eaves of homes. They can be buried, with a different type of trigger fuse as described above. They can be molded into baseboards or crown moldings inside buildings, mounted in the attic, crawlspace, or inside walls. They can be mounted near or inside electrical breaker panels, or near high-voltage appliances such as ovens or electric car chargers. They can be mounted under the hoods of vehicles, or in hard-to-reach places like large building electrical conduits. They can be designed to float, such as an emergency measure inside large fuel reservoirs or deployed during an aquatic oil spill. They could also be mounted inside shipping containers that have a potential fire risk, or inside aircraft or submarines because the described fire suppression apparatus is not pressure or temperature sensitive, only activated by flame.

Further, the deployment of the fire suppression system 802 takes into account where it is placed and how. The first firefighters on the scene of a small, beginning fire might encircle the fire to minimize its spread, and as the fire burns, the firefighters may use it to direct the fire's advance by deploying a fire suppression barrier along one side of the fire. When there are buildings, crops, or other property assets that need to be protected, they could deploy multiple concentric fire suppression systems around a property asset, or between the property asset and the fire. Additionally, specialized tools, deployment apparatuses, or mounting options can be implemented for use, such as shipping boxes, truck-mounted boxes or reels, devices for combining multiple ropes together (or separating them), mounting straps, charge-deactivating chemical syringes, and disposal drums, to name a few non-limiting examples. For example, a truck bed carrier can be implemented specifically for pickup-type vehicles that can carry multiple rows, columns, and layers of the fire suppression apparatuses and/or fire suppression systems for distribution or deployment.

FIG. 9 illustrates example method(s) 900 of a fire suppression apparatus. The order in which the method is described is not intended to be construed as a limitation, and any number or combination of the described method operations can be performed in any order to perform a method, or an alternate method.

At 902, one or more fire extinguishing agents are contained. For example, the elongated housing 102 of the fire suppression apparatus 100 (FIG. 1) contains the one or more fire extinguishing agents 104 that are expelled from the elongated housing responsive to activating the explosive charge 110 by a trigger fuse 112. Similarly, the elongated housing 302 of the fire suppression apparatus 300 contains the one or more fire extinguishing agents 304 that are expelled from the elongated housing responsive to activating the explosive charge 306 by the trigger fuse 308.

At 904, a trigger fuse is ignited by an approaching flame. For example, the trigger fuse 112 of the fire suppression apparatus 100 is ignited based on a waterproof element of the elongated housing melting to expose the trigger fuse to fire. Similarly, the trigger fuse 308 of the fire suppression apparatus 300 is ignited when exposed to fire.

At 906, an explosive charge is activated by the trigger fuse. For example, the explosive charge 110 in the fire suppression apparatus 100 is activated by a trigger fuse 112 that has been ignited by a flame. Similarly, the explosive charge 306 in the fire suppression apparatus 300 is activated by the trigger fuse 308 that has been ignited by a flame.

At 908, the one or more fire extinguishing agents are expelled by the explosive charge. For example, the one or more fire extinguishing agents 104 in the fire suppression apparatus 100 are expelled by the explosive charge 110 when the explosive charge is activated by a trigger fuse 112 that has been ignited by a flame. Similarly, the one or more fire extinguishing agents 304 in the fire suppression apparatus 300 are expelled by the explosive charge 306 when the explosive charge is activated by the trigger fuse 308 that has been ignited by a flame.

At 910, the one or more fire extinguishing agents are distributed in a first direction to suppress a fire responsive to the explosive charge activating. For example, the one or more fire extinguishing agents 104 in the fire suppression apparatus 100 are distributed in the first direction 602 to suppress the fire 502 responsive to the explosive charge 110 activating. Similarly, the one or more fire extinguishing agents 304 in the fire suppression apparatus 300 are distributed in the first direction 602 to suppress the fire 502 responsive to the explosive charge 306 activating.

At 912, the one or more fire extinguishing agents are distributed in a second direction to protect unburned fire fuel responsive to the explosive charge activating. For example, the one or more fire extinguishing agents 104 in the fire suppression apparatus 100 are distributed in the second direction 604 to protect unburned fire fuel responsive to the explosive charge 110 activating. Similarly, the one or more fire extinguishing agents 304 in the fire suppression apparatus 300 are distributed in the second direction 604 to protect unburned fire fuel responsive to the explosive charge 306 activating.

1. A fire suppression apparatus, comprising:
an elongated housing configured to contain one or more fire extinguishing agents;
an explosive charge within the elongated housing; and
at least one trigger fuse configured to ignite reactive to flame exposure, the at least one trigger fuse activating the explosive charge to expel the one or more fire extinguishing agents.

2. The fire suppression apparatus of claim 1, wherein at least the elongated housing and the one or more fire extinguishing agents are biodegradable.

3. The fire suppression apparatus of claim 2, wherein the elongated housing is formed from natural earthen elements.

4. The fire suppression apparatus of claim 2, wherein the one or more fire extinguishing agents are biodegradable fertilizers.

5. The fire suppression apparatus of claim 1, wherein the elongated housing is configured to distribute the one or more fire extinguishing agents in two directions responsive to the explosive charge activating, the one or more fire extinguishing agents distributable in a first direction towards a fire and distributable in a second direction opposite the first direction.

6. The fire suppression apparatus of claim 5, wherein the one or more fire extinguishing agents distributed in the first direction are configured to suppress the fire, and the one or more fire extinguishing agents distributed in the second direction are configured to protect unburned fire fuel.

7. The fire suppression apparatus of claim 1, wherein the elongated housing is configured with a waterproof sealant, and wherein the waterproof sealant is configured to melt due to the flame exposure, exposing the at least one trigger fuse to a fire.

8. A fire suppression system, comprising:
a first fire suppression apparatus containing one or more fire extinguishing agents configured to expel from an elongated housing responsive to an explosive charge activated by a trigger fuse ignited by flame exposure; and
at least a second fire suppression apparatus linked for deployment with the first fire suppression apparatus.

9. The fire suppression system of claim 8, wherein at least the elongated housing and the one or more fire extinguishing agents are biodegradable.

10. The fire suppression system of claim 9, wherein the elongated housing is formed from natural earthen elements.

11. The fire suppression system of claim 9, wherein the one or more fire extinguishing agents are biodegradable fertilizers.

12. The fire suppression system of claim 8, wherein the elongated housing is configured to distribute the one or more fire extinguishing agents in a first direction to suppress a fire responsive to the explosive charge activated by the trigger fuse.

13. The fire suppression system of claim 12, wherein the elongated housing is configured to distribute the one or more fire extinguishing agents in a second direction, opposite the first direction, to protect unburned fire fuel responsive to the explosive charge activated by the trigger fuse.

14. The fire suppression system of claim 8, wherein multiple fire suppression apparatuses, including the first fire suppression apparatus and at least the second fire suppression apparatus, are linked for deployment in a path of a fire.

15. A method, comprising:
containing one or more fire extinguishing agents;
igniting, by an approaching flame, a trigger fuse;
activating an explosive charge by the trigger fuse; and
expelling the one or more fire extinguishing agents by the explosive charge.

16. The method of claim 15, further comprising:
distributing the one or more fire extinguishing agents in a first direction to suppress a fire responsive to activating the explosive charge.

17. The method of claim 16, further comprising:
distributing the one or more fire extinguishing agents in a second direction to protect unburned fire fuel responsive to activating the explosive charge.

18. The method of claim 15, wherein the igniting the trigger fuse is based on a waterproof element that melts to expose the trigger fuse to fire.

19. The method of claim 15, wherein a fire suppression apparatus contains the one or more fire extinguishing agents configured for expelling from an elongated housing responsive to activating the explosive charge by the trigger fuse.

20. The method of claim 19, wherein:
multiple of the fire suppression apparatus are linked for deployment as a barrier in a path of an advancing fire; and
the multiple fire suppression apparatuses are deployable from a vehicle in the path of the advancing fire.
